(19) United States
(12) Patent Application Publication
(10) Pub. No.: US 2026/0170168 A1
(43) Pub. Date: Jun. 18, 2026

(54) SECURE INLINE FRAME ISOLATION

(71) Applicant: Stripe, LLC, South San Francisco, CA (US)

(72) Inventors: Jorge Eugenio AGUIRRE GONZALEZ, Bothell, WA (US); Michael HINES, Chicago, IL (US); William KIRK, New York, NY (US); Samuel De Jun Victor LYE, Weehawken, NJ (US); Jason GUPTA, San Francisco, CA (US); Daryl KOOPERSMITH, Brooklyn, NY (US); James LONG, Midlothian, VA (US); Soya QIAN, Brooklyn, NY (US)

(21) Appl. No.: 18/986,558

(22) Filed: Dec. 18, 2024

(51) Int. Cl. G06F 21/62; G06F 21/31

(52) U.S. Cl. CPC G06F 21/6245; G06F 21/31

(57) ABSTRACT

An inline frame for transactions, or services, via a parent frame from a platform may maintains the same developer interface from the platform and isolating a transaction from the platform. A service provider receives and processes the transaction by requesting the parent frame open an inline frame, and then renders a user interface in the inline frame to, for example, provide additional transaction-based data or receive an account credential. The inline frame may appear to users as part of the parent frame. However, due to the user interface being rendered in the inline frame, the parent frame and the user interface are in different domains, and the platform or the parent frame cannot receive or surface data rendered or provided in the inline frame. The service provider server notifies the platform when the transaction is complete, allowing the service provider server to maintain loss liability without surfacing sensitive information.

### TECHNICAL FIELD

The present description generally relates to inline frames, and more particularly, to using inline frames in conjunction with a frame.

### BACKGROUND

Service providers may be used to process a transaction on behalf of a platform. One exemplary approach includes the use of embedding the code (e.g., user interface code) in a parent frame owned by the platform server.

### BRIEF DESCRIPTION OF THE DRAWINGS

Certain features of the subject technology are set forth in the appended claims. However, for the purpose of explanation, several implementations of the subject technology are set forth in the following figures.

FIG. 1 illustrates an example of a network environment of a processing system in which a service provider server is used with a platform server to perform a transaction with the platform server, in accordance with one or more implementations.

FIG. 2 illustrates a block diagram of an example electronic device, in accordance with one or more implementations.

FIG. 3 illustrates a block diagram of a parent frame, showing data provided to the parent frame by a platform server and a service provider server, in accordance with one or more implementations.

FIG. 4 illustrates a block diagram of a parent frame showing various portions isolated from other portions, in accordance with one or more implementations.

FIG. 5, FIG. 6, FIG. 7, and FIG. 8 illustrate respective flowcharts showing various processes that may be conducted through a parent frame, in accordance with one or more implementations.

FIG. 9 illustrates an example electronic system with which aspects of the present disclosure may be implemented, in accordance with one or more implementations.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

The present disclosure is directed to using inline frames embedded within a parent frame (e.g., web page for a platform) to provide a user interface (UI) that is rendered in the inline frames and thus isolated from the parent frame. In conjunction with web UI developers, platform UI developers for a platform (e.g., merchant, business, etc.) may develop, render, and/or manage embedded components (e.g., platform UI, data) for the parent frame, while UI developers for a service render embeddable components for the inline frame. In one or more implementations, the service provides a UI framework that works in conjunction with instructions (e.g., executable instructions) for the parent frame, allowing the UI framework code to run with the parent frame code. The UI framework may enable UI isolation for UI rendered in the inline frames. In order to render UI in an inline frame, the UI framework allows for messaging channels to communicate various requests to and from the parent frame. For example, when components of the parent frame are updated, the UI framework may also be updated. When an inline frame determines a transaction is required (e.g., based on the updates or via a request from the parent frame), the UI framework messages the parent frame a request to open an additional inline frame, and the UI framework renders one or more UI in the inline frame. In one or more implementations, the UI framework facilitates a transaction on behalf of the platform. As non-limiting examples, a transaction may include a payment transaction, an account onboarding of a payment credential, or account management of a user account.

Additionally, the UI framework may provide via the messaging channel a size (e.g., one or more dimensions) and/or location for the inline frame. The size of the inline frame may be a size sufficient to render UI within the inline frame, while the location may be based on a location of an embedded component in the parent frame or another inline frame. In some instances, the inline frame may be superimposed over the parent frame so as to appear (e.g., to a user) to be part of the parent frame. However, the component(s) rendered in the inline frame are isolated from the parent frame (and the platform), thus preventing the platform from surfacing the components and the data in the inline frame. Additionally, the UI framework may include instructions for a resize observer that monitors for a change in size to the parent frame, including a change in size of the components (e.g., text, images, etc.) of the parent frame or the parent frame itself. In this regard, the UI framework may adjust, including increase or decrease, the components in the inline frame to match an increase or decrease, respectively, of the components of the parent frame after the resize of the parent frame.

In some instances, the UI in the inline frame is constrained to a box, or window, defined by the perimeter of the inline frame, and additional UI may be necessary to, for example, perform a transaction. The UI framework may send an additional message to request the parent frame open an additional inline frame, allowing the UI framework to render additional UI in the additional inline frame. Further, when the inline frame(s) are no longer in use, the UI framework may message the parent frame a request to close the inline frame, and the parent frame closes the inline frame. As an example, the completion of a transaction may trigger the UI framework to trigger the parent frame to close the inline frame(s). When the transaction is complete, the UI framework may further provide a message (e.g., approval message) that the transaction is complete.

By using the UI framework and the messaging channel, the service may not directly communicate sensitive information (e.g., payment information, account credential, etc.) to the platform without the sensitive information being visible or intercepted by the parent frame. Beneficially, a transaction may proceed securely via the UI framework without compromising user data. Additionally, the UI framework may maintain the same developer interface (e.g., same programming language) for UI platform developers, as well as maintain the same developer experience for web UI developers. Further, the UI may remain consistent, or generally consistent, for end users (e.g., customers) using the UI on the parent frame.

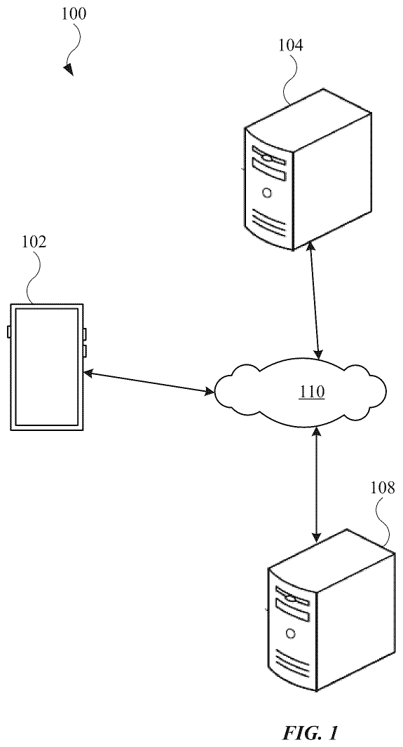

FIG. 1 illustrates an example of a network environment 100 of a processing system in which a service provider server is used with a platform server to perform a transaction with the platform server, in accordance with one or more implementations. Not all of the depicted components may be used in all implementations, however, and one or more implementations may include additional or different components than those shown in FIG. 1. Variations in the arrangement and type of the components may be made without departing from the spirit or scope of the claims as set forth herein. Additional components, different components, or fewer components may be provided.

The network environment 100 may include an electronic device 102, a service provider server 104 and platform server 108. The network environment 100 may further include a network 110 communicatively (directly or indirectly) coupled with one or more of the electronic device 102, the service provider server 104, and the platform server 108. In one or more implementations, the network 110 may be an interconnected network of devices that may include, or may be communicatively coupled to, the Internet. For explanatory purposes, the network environment 100 is illustrated in FIG. 1 as including the electronic device 102, the service provider server 104 the platform server 108, and the network 110. However, the network environment 100 may include any number of electronic devices and/or any number of servers communicatively coupled to each other directly or via the network 110.

The electronic device 102 may take the form of, for example, a wearable device such as a watch (or smartwatch), a desktop computer, a portable computing device (e.g., a laptop computer, a smartphone, a peripheral device such as a digital camera or headphones, a tablet device), or any other appropriate device that includes, for example, one or more wireless interfaces, such as WLAN radios, cellular radios, Bluetooth radios, Zigbee radios, near field communication (NFC) radios, and/or other wireless radios. In FIG. 1, by way of example, the electronic device 102 is depicted as a smartphone. Also, the communication among the service provider server 104, and the platform server 108 may be through respective servers of the service provider server 104, and the platform server 108.

The service provider server 104 may include a payment server. In this regard, the service provider server 104 may include a payment processing platform that provides a variety of payment-based services for a user interacting with the service provider server 104 through the electronic device 102. As non-limiting examples, the service provider server 104 may send payments on behalf of users and third parties, accept payments on behalf of users and third parties, receive requests from users or third parties to process a payment, and manage business activities for users and third parties. Further, the user may interact with the service provider server 104 by one or more of a software application, or app, running on the electronic device 102 or a website running on a web browser on the electronic device 102.

The platform server 108 may correspond to businesses such as merchants (e.g., an entity or retailer that sells merchandise or goods), restaurants, establishment for providing accommodations (e.g., hotel), or service providers (e.g., utility provider), as non-limiting examples. The platform server 108 may provide data for a frame (e.g., parent frame, website, app), hosted directly or indirectly (e.g., by a third party hosting service), for presenting one or more items (e.g., goods, services) to a user of the electronic device 102.

In one or more implementations, a user interacts with the electronic device 102 to initiate a transaction, using the service provider server 104, in order to perform a transaction with an entity corresponding to the platform server 108. In order to complete the transaction, the platform server 108 may request the service provider server 104 to provide user account data such as an account access token, an account number, and the like. The service provider server 104 may prompt the user to provide a credential. In one or more implementations, the service provider server 104 utilizes an inline frame to facilitate a transaction, with the inline frame isolating the authentication credentials from the platform server 108. This will be shown and described in further detail below. In one or more implementations, the service provider server 104 may provide the account authentication credentials to a financial institution server 106, and if verified by the financial institution server, the service provider server 104 receives an access token and/or account number from the financial institution server 106 and provides the platform server 108 with a notification indicating the transaction is complete.

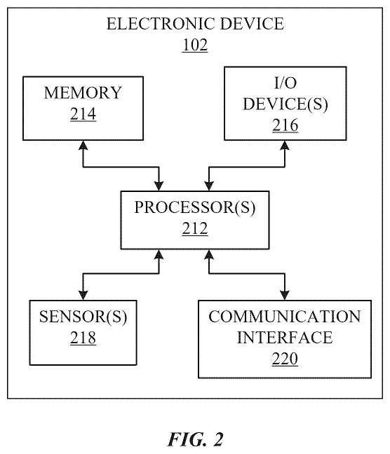

FIG. 2 illustrates an example of an electronic device 102 that may be used in a processing system described herein. The electronic device 102 may include any features and/or functions described herein for the electronic device 102 (shown in FIG. 1). Further, the electronic device 102 shown in FIG. 2 may be implemented in any other electronic device for use with the subject technology. Not all of the depicted components may be used in all implementations, however, and one or more implementations may include additional or different components than those shown in FIG. 2. Variations in the arrangement and type of the components may be made without departing from the spirit or scope of the claims as set forth herein. Additional components, different components, or fewer components may be provided.

The electronic device 102 may include one or more of a one or more processors 212, a memory 214, one or more input-output devices 216 (I/O DEVICE(S)), one or more sensors 218, and a communication interface 220. The one or more processors 212 may include suitable logic, circuitry, and/or code that enable processing data and/or controlling operations of the electronic device 102. In this regard, the one or more processors 212 may be enabled to provide control signals to various other components of the electronic device 102. The one or more processors 212 may also control transfers of data between various portions of the electronic device 102. The one or more processors 212 may further implement an operating system or may otherwise execute code to manage operations of the electronic device 102. The one or more processors 212 are communicatively coupled to the various components shown in FIG. 2.

The memory 214 may include suitable logic, circuitry, and/or code that enable storage of various types of information such as received data, generated data, code, and/or configuration information. The memory 214 may include volatile memory (e.g., random access memory (RAM)) and/or non-volatile memory (e.g., read-only memory (ROM), flash, and/or magnetic storage). In one or more implementations, the memory 214 may store user account data, and any other data generated in the course of performing the processes described herein.

The one or more input-output devices 216 may include a display. In one or more implementations, the display includes a capacitive touch input display, thus allowing the user to interact with the electronic device 102 by a touch input or gesture to the display. Additionally, the one or more input-output devices 216 may include one or more buttons, which may be actuated by a user. The one or more input-output devices 216, while taking the form of a display and/or buttons, may be used to provide an input to the one or more processors 212 in order to, for example, initiate a service through a service provider.

The one or more sensors 218 may include one or more microphones and/or cameras. The microphones may obtain audio signals, such as voice commands from a user to initiate or confirm service processing using a service provider. For example, the microphones may obtain audio of the user reading a passphrase or authentication code. The cameras may be used to capture images corresponding to identity data and/or credentials. For example, the cameras may capture images of a user (e.g., a selfie) for comparison against a database of images of users, may capture images of a user's identity credentials, such as driver's license, passport, etc., and/or may be used for a “liveness” determination.

The communication interface 220 may include suitable logic, circuitry, and/or code that enables wired or wireless communication, such as between the electronic device 102 and the network 110 (shown in FIG. 1). The communication interface 220 may include, for example, one or more of a Bluetooth communication interface, an NFC interface, a Zigbee communication interface, a WLAN communication interface, a USB communication interface, a cellular interface, or generally any communication interface.

In one or more implementations, the one or more processors 212, the memory 214, the one or more input-output devices 216, the one or more sensors 218, the communication interface 220, and/or one or more portions thereof may be implemented in software (e.g., subroutines and code), may be implemented in hardware (e.g., an Application Specific Integrated Circuit (ASIC)), a Field Programmable Gate Array (FPGA), a Programmable Logic Device (PLD), a controller, a state machine, gated logic, discrete hardware components, or any other suitable devices) and/or a combination of both.

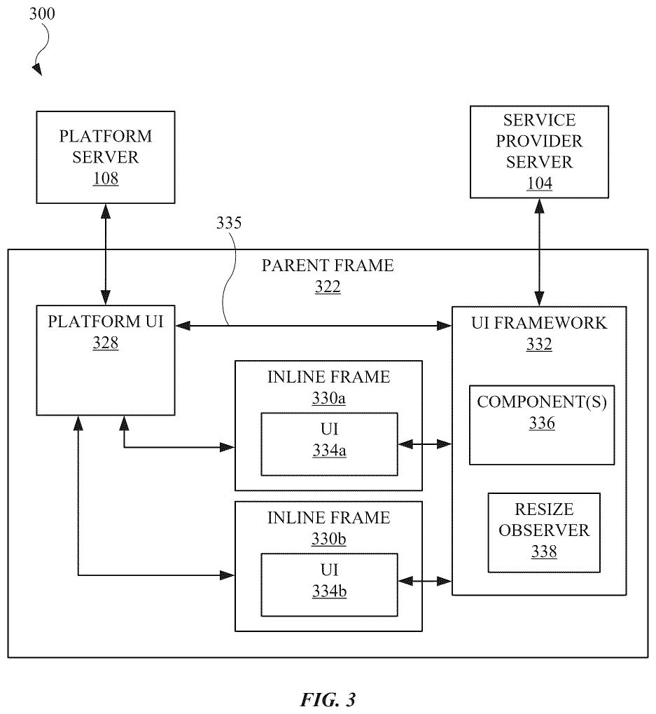

FIG. 3 illustrates a block diagram 300 of a parent frame 322, showing data provided to the parent frame 322 by the platform server 108 and the service provider server 104, in accordance with one or more implementations. The parent frame 322 is shown as a web page. However, the parent frame 322 may take the form of a mobile-based software application (e.g., app). The platform server 108 may function as the proprietor of the parent frame 322 by directly or indirectly controlling at least some of the content (e.g., visual information) provided on the parent frame 322. In this regard, the platform server 108 may provide platform UI 328 to the parent frame 322. The platform UI 328 may provide instructions for the layout of the parent frame 322, including text, embedded components, etc. The platform UI 328 may further provide instructions for generating inline frames, such as an inline frame 330a and an inline frame 330b, each of which may be representative of one or more additional inline frames.

The service provider server 104 may provide UI framework 332 to the parent frame 322. The UI framework 332 may provide instructions for rendering a UI 334a and a UI 334b in the inline frame 330a and the inline frame 330b, respectively. The UI framework 332 may render one or components 336 for each of the UI 334a and the UI 334b. For example, the one or more components 336 may include UI components, such as a dialog, a tooltip, a dropdown, a text field, a popover, a request for an account credential, a request for a payment credential, or a combination thereof. It should be noted that a component(s) of the one or more components 336 rendered by the UI framework 332 in the UI 334a within the inline frame 330a may be different from a component(s) of the one or more components 336 rendered by the UI framework 332 rendered in the UI 334b.

To perform various functions for the parent frame 322, the UI framework 332 and the platform UI 328 may establish a message channel 335 for communication. In this regard, the platform UI 328 may update one or more components to, for example, initiate a service for a user. The UI framework 332 may provide a message via the message channel 335 to the platform UI 328 to open at least the inline frame 330a. Moreover, the UI framework 332 may further message the platform 328 not only the size of the inline frame 330a (which is based at least in part on the component of the one or more components 336) but also the location of the inline frame 330a. The location of the inline frame 330a may be based in part on a location(s) of one or more components of the platform UI 328. The location may be provided via location data (e.g., coordinates). The platform UI 328 may provide a message via the message channel 335 to the UI framework 332 indicating the inline frame 330a is generated. The message channel 335 may further be used as a communication channel between the parent frame 322 and the inline frame 330a. Further, the platform UI 328 may assign an identifier to the inline frame 330b and provide the identifier to the framework UI 332. The identifier may include a string of numbers, letters, or a combination thereof, such that inline frame 330b is uniquely recognized. The UI framework 332 may utilize the identifier to recognize the inline frame 330b in order to render the desired content in the inline frame 330b. The UI framework 332 may render the UI 334a within the inline frame 330a, with the UI 334a including a component(s) of the one or more components 336. The inline frame 330a may be superimposed over a region of the parent frame 32, causing the UI 334a in the inline frame 330a to appear (e.g., to a user) to be a component or part of the platform UI 328.

In one or more implementations, a user interaction with the UI 334a is identified, with the user interaction requiring additional data to be presented in order to complete a transaction. For example, when a user places a cursor over a region of the inline frame 330a or the UI 334a within the inline frame 330a, a component (e.g., tooltip, popover) may be required to complete a transaction. As another example, a user may select via touch input to a display a location corresponding to the inline frame 330a or the UI 334a within the inline frame 330a, requiring a component to be generated. The identifying of a user request may include electronic device (e.g., electronic device 102 shown in FIGS. 1 and 2), including a display of the electronic device, identifying the cursor or the touch input. The UI framework 332 may provide a message to the platform UI 328 to request that the platform UI 328 open the inline frame 330b. When the platform UI 328 provides a response message to the UI framework 332 indicating the UI 334b is generated, the UI framework 332 may render the UI 334b, using the one or more components 336, within the inline frame 330b. Similar to the inline frame 330a, the UI framework 332 may provide a message with instructions with regard to the size and location of the inline frame 330b.

Based on the inline frame 330a and the inline frame 330b, the UI 334a and the UI 334b, respectively, may be isolated from the parent frame 322 and the platform server 108. As a result, the data provided by the UI 334a and the UI 334b may not be accessible to the platform server 108. This may further include information (e.g., account credential) provided by a user in the inline frame 330a and/or the inline frame 330b.

The UI framework 332 may further include instructions for a resize observer 338 that functions to monitor changes to the components rendered by the platform UI 328 and/or the size of the parent frame 322. For example, when the platform UI 328 adjusts the size (e.g., one or more dimensions) of one or more components, the resize observer 338 may monitor and determine the size adjustment, and the UI framework 332 may provide a message to the platform UI 328 to resize (e.g., adjust one or more dimensions of) the inline frame 330a (and the inline frame 330b, if generated by the platform UI 328) in accordance with the size adjustment of the components of the platform UI 328. Accordingly, when the components of the platform UI 328 increase in size, the resize observer 338 may monitor and determine the increase of the size of the components and the UI framework may provide a message to the platform UI 328 to increase the size of the inline frame 330a in proportion to the increase in the size of the components of the platform UI 328. The UI framework 332 may further increase the size of the UI 334a (and the UI 334b, if generated). A similar operation may occur when the components of the platform UI 328 decrease in size. Also, when a transaction is completed or approved, the UI framework 332 may provide a message to close the inline frame 330a (and the inline frame 330b, if generated).

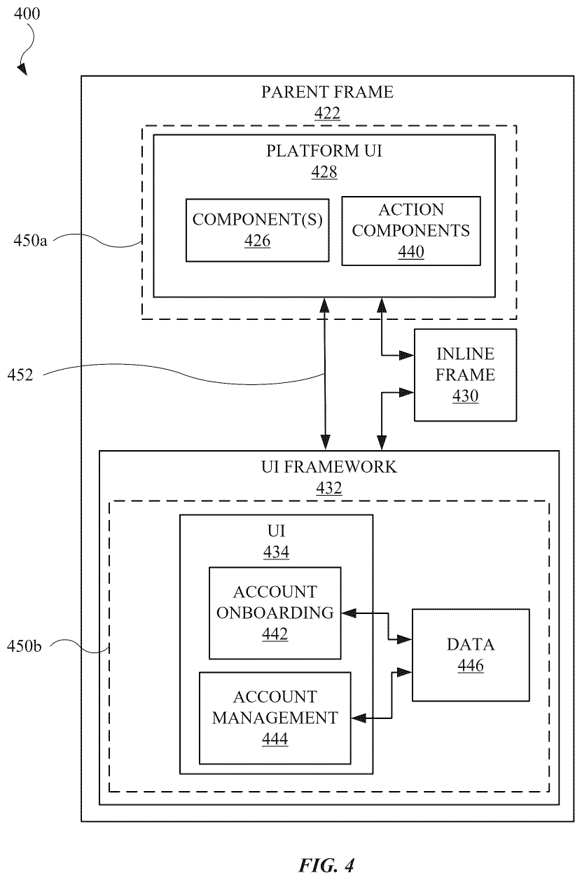

FIG. 4 illustrates a block diagram 400 of a parent frame 422 showing various portions isolated from other portions, in accordance with one or more implementations. As shown, the parent frame 422 includes a platform UI 428 and UI framework 432. The platform UI 428 may be provided by a platform server (e.g., platform server 108 shown in FIG. 1) and the UI framework 432 may be provided by a service provider server (e.g., service provider server 104 shown in FIG. 1). In some embodiments, inline frames maybe used to complete actions, In one embodiment, the action could be to facilitate a transaction (e.g., payment transaction), the platform UI 428 may provide instructions to generate one or one or more components 426. The one or more components 426 may include instructions for generating UI components, such as a dialog, a tooltip, a dropdown, a text field, a popover, or a combination thereof. This will be discussed in further detail below. In the exemplary embodiment of completing an action (e.g., a transaction), the platform UI 428 may further provide instructions to generate action components 440. The action components 440 may include, for example, the cost of one or more items a user wishes to purchase via the platform frame 422. Additionally, the parent frame 422 may include instructions for generating an inline frame 430 (representative of one or more inline frames).

The UI framework 432 may include one or more UI 434 and a data 446. The one or more UI 434 may include instructions for generating components such as account onboarding 442 and account management 444. The account onboarding 442 may include a request for a user to provide a credential. In some embodiments, the credential is a payment credential. The account management 444 may include a request to provide an account credential. The UI framework 432 may further include instructions for data 446 to populate, for example, text into the account onboarding 442 and/or the account management 444.

Several components in the parent frame 422 may lack the ability to directly communicate instructions and/or code to other components. For example, a region 450a may include several features of the platform UI 428, such as the one or more components 426 and payment details. Further, a region 450b may include several features of the UI framework 432, such as the one or more UI 434 and the data 446. The respective instructions used to generate the features in the region 450a may not be directly communicated with the respective instructions used to generate the feature in the region 450b, and vice versa. Rather, a message channel 452 may be established between the platform UI 428 and the UI framework 432, allowing the exchange of messages between the components and features of the region 450a and the region 450b. Using the message channel 452, certain features may be isolated from other components and/or features. For example, the UI rendered by the one or more UI 434 within the inline frame 430 may be isolated from the parent frame 422, as well as a platform server (not shown in FIG. 4) associated with the parent frame 422. The message channel 452 may further be used by as a communication channel between the parent frame 422 and the inline frame 430. Beneficially, a transaction may proceed securely via the UI framework 432 without compromising user data, as the parent frame 442 may not surface sensitive user data.

In an example implementation, a user may interact with the platform UI 428 to perform a transaction or service. The platform UI 428 may generate instructions for the action components 440, which may include the cost of one or more items selected by the user. The platform UI 428 may provide via the message channel 452 a request to the UI framework 432 to process the transaction. The platform UI 428 may further provide the action components 440 to the UI framework 432 via the message channel 452. The UI framework 432 may provide via the message channel 452 a request to the platform UI 428 to open the inline frame 430. The UI framework 432 may provide via the message channel 452 a request to the platform UI 428 to open the inline frame 430 with a specified size and/or specified location. The one or more UI 434, in conjunction with the data 446, may render UI within the inline frame 430. As non-limiting examples, the one or more UI 434 may generate instructions for account onboarding 442, which may include a request for the user to provide a user credential (e.g., username and password) to access an account associated with the parent frame 422 or a payment request for the user to provide an account credential (e.g., financial account credential) to purchase the one or more items. When the user provides the requested credential via the one or more UI 434 provided within the inline frame 430, the transaction may be processed (e.g., the one or more items may be purchased). When the transaction is complete, the UI framework 432 may provide via the message channel 452 a notification to the platform UI 428 indicating an approval of the transaction (e.g., the transaction is complete). In one or more implementations, a financial institution server may receive an account credential or payment credential, authenticate the credential, and approve/authorize the transaction. The notification may cause the parent frame 422 to close the inline frame 430. Alternatively, the UI framework 432 may provide an additional notification via the message channel 452 to the platform UI 428 to close the inline frame 430. When the inline frame 430 is closed, the UI framework 432 may close the one or more UI 434 and the data 446.

Although not expressly shown, the features of the parent frame 422 may include similar functionality as that of the parent frame 322 (shown in FIG. 3). For example, UI framework 432 may send via the message channel 452 a request to the platform UI 428 to open an additional inline frame. In this regard, the one or more UI 434 and the data 446 may generate instructions for a component(s) such as a such as a dialog, a tooltip, a dropdown, a text field, a popover, or a combination thereof. The component(s) may be rendered in the additional inline frame. The UI framework 432 may send via the message channel 452 a request to the platform UI 428 to open the additional inline frame with a specified size and/or specified location. The UI framework 432 may further include instructions for a resize observer that monitors for a resizing of one or more components rendered on the platform UI 428, and when a resize is detected, the UI framework 432 may send via the message channel 452 a request to the platform UI 428 to resize the inline frame 430 and the additional inline frame. The one or more UI 434 and the data 446 may adjust the rendering in the inline frame 430 and the additional inline frame in response an adjustment of the size of the inline frame 430 and the additional inline frame. In addition to providing a secure transaction, the UI framework 432 may maintain the same developer interface (e.g., same programming language) for UI platform developers, as well as maintain the same developer experience for web UI developers. Further, the one or more UI 434 may remain consistent, or generally consistent, for end users (e.g., customers) using the UI on the parent frame 422.

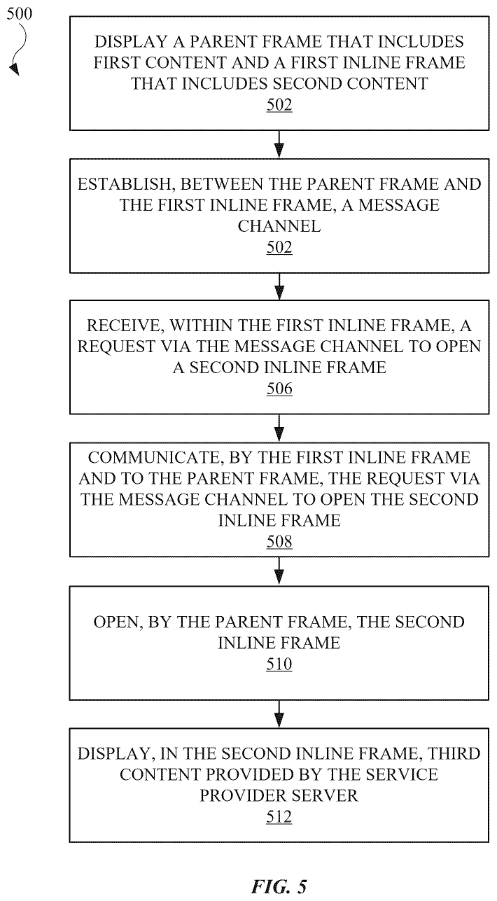

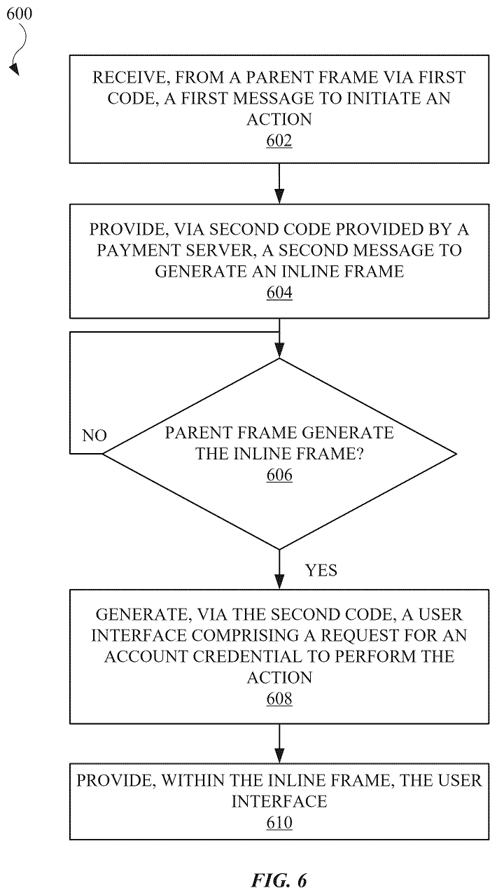

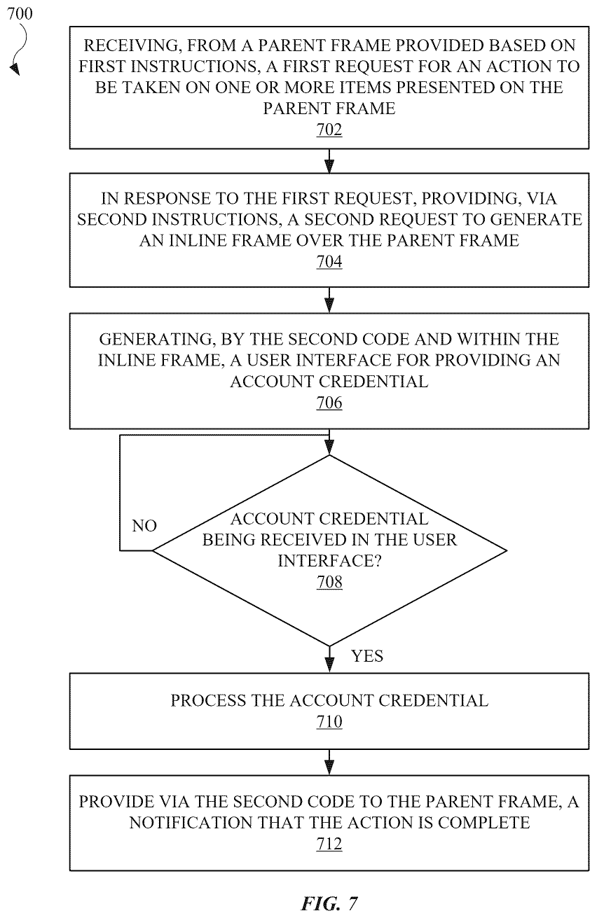

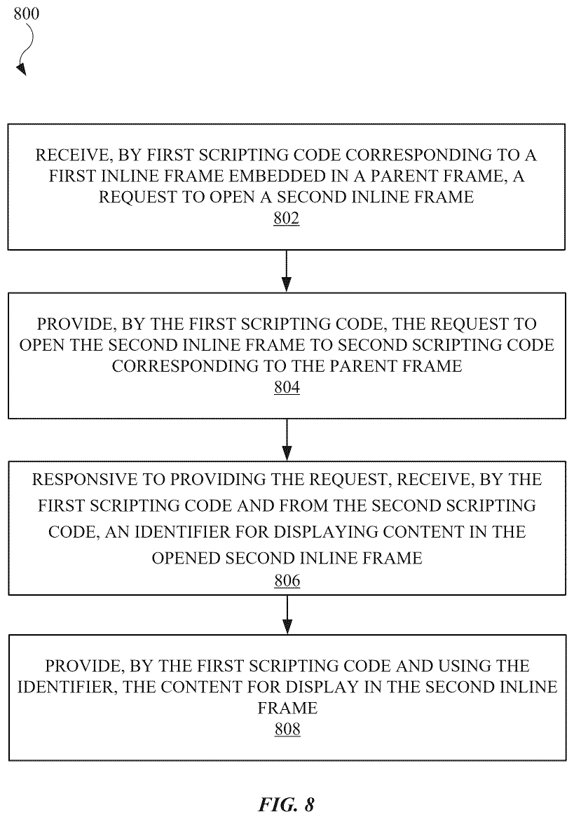

FIG. 5, FIG. 6, FIG. 7 and FIG. 8 illustrate respective flowcharts showing various processes that may be conducted in part by a service provider server, in accordance with one or more implementations. The processes shown in the flowcharts may be conducted by a non-transitory computer-readable medium used with a payment provider described herein.

FIG. 5 illustrates a flowchart 500 showing a method for managing a transaction through a parent frame (e.g., parent frame 322 and parent frame 422 shown in FIG. 3 and FIG. 4, respectively). In step 502, a parent frame (e.g., parent frame 322 shown in FIG. 3) that includes first content (e.g., from the platform UI 328 shown in FIG. 3) and a first inline frame (e.g., inline frame 330a shown in FIG. 3) that includes second content (e.g., from the UI layer 334a shown in FIG. 3) are displayed. The first content of the parent frame may be provided by a platform server and the second content of the inline frame may be provided by a service provider server separate from the platform server.

In step 504, a message channel is established between the parent frame and the first inline frame. The platform UI and the UI framework In step 506, a request via the message channel is received within the first inline frame to open a second inline frame (e.g., inline frame 330b shown in FIG. 3). In one or more implementations, additional UI or data used to perform a service requires the second inline frame.

In step 508, the first inline frame communicates to the parent frame the request via the message channel to open the second inline frame. In one or more implementations, the second inline frame is used on conjunction with the first inline frame to perform a service or transaction.

In step 510, the parent frame opens the second inline frame. The second inline frame may be populated with UI (e.g., UI 334b shown in FIG. 3) to perform the service.

In step 512, third content (e.g., from the UI 334b shown in FIG. 3) provided by the service provider server is displayed in the second inline frame. The third content may be displayed on a device (e.g., electronic device 102 shown in FIG. 1).

FIG. 6 illustrates a flowchart 600 showing an alternate method for managing a transaction through a parent frame (e.g., parent frame 322 and parent frame 422 shown in FIG. 3 and FIG. 4, respectively). In step 602, a first message is received, from a parent frame (e.g., parent frame 422 shown in FIG. 4) via first instructions, to initiate an action.

In step 604, a second message is provided, via second instructions provided by a service provider server (e.g., service provider server 104 shown in FIG. 1), to generate an inline frame (e.g., inline frame 430 shown in FIG. 4).

In step 606, a decision is made whether the parent frame generated the inline frame. If the decision is no, the flowchart 600 returns to step 606. If the decision is yes, the flowchart 600 proceeds to step 608.

In step 608, a user interface (e.g., one or more UI 434 shown in FIG. 4) that includes a request for an account credential to perform the payment transaction is generated via the second instructions. The account credential may include a credential provided by a user to proceed with the action.

In step 610, the user interface is rendered within the inline frame. The user interface may include a request to the user to provide the account credential.

FIG. 7 illustrates a flowchart 700 showing an alternate method for managing a transaction through a parent frame (e.g., parent frame 322 and parent frame 422 shown in FIG. 3 and FIG. 4, respectively). In step 702, a first request for an action to be taken on one or more items presented on the parent frame is received from a parent frame (e.g., parent frame 422 shown in FIG. 4) provided based on first instructions.

In step 704, in response to the first request, a second request to generate an inline frame (e.g., inline frame 430) over the parent frame is provided via second instructions.

In step 706, a user interface (e.g., one or more UI 434) for providing an account credential generated by the second instructions and within the inline frame. The user interface may include details for account onboarding or account management.

In step 708, a decision is made whether the account credential is received in the user interface. If the decision is no, the flowchart 700 returns to step 708. If the decision is yes, the flowchart 700 proceeds to step 710.

In step 710, the account credential is processed. UI framework (e.g., UI framework 432 shown in FIG. 4) may process the account credential. Alternatively, a service provider server (e.g., a service provider server 104 shown in FIG. 1) or a financial institution server may be utilized in combination with the UI framework to process the account credential.

In step 712, a notification is provided, via the second code to the parent frame, that the action is complete. The notification may be provided from the UI framework (e.g., UI framework 432 shown in FIG. 4) to a platform UI (e.g., (e.g., platform UI 428 shown in FIG. 4) via a message channel (e.g., message channel 452 shown in FIG. 4).

FIG. 8 illustrates a flowchart 800 showing an alternate method for managing a transaction through a parent frame (e.g., parent frame 322 and parent frame 422 shown in FIG. 3 and FIG. 4, respectively). In step 802, a request is received, by first scripting code (e.g., UI framework 332 shown in FIG. 3) corresponding to a first inline frame (e.g., inline frame 330a shown in FIG. 3) embedded in a parent frame, to open a second inline frame (e.g., inline frame 330b shown in FIG. 3). The first scripting code is provided by a first server (e.g., service provider server 104 shown in FIG. 3).

In step 804, the first scripting code provides the request to open the second inline frame to second scripting code (e.g., platform UI 328 shown in FIG. 3) corresponding to the parent frame. The second scripting code is provided by a second server (e.g., platform server 108 shown in FIG. 3).

In step 806, in response to providing the request, the first scripting code receives, from the second scripting code, an identifier for displaying content (e.g., UI 334b shown in FIG. 3) in the opened second inline frame.

In step 808, using the identifier, the first scripting code provides the content for display in the second inline frame. The content may include, for example, such as a dialog, a tooltip, a dropdown, a text field, a popover, a request for an account credential, a request for a payment credential, or a combination thereof.

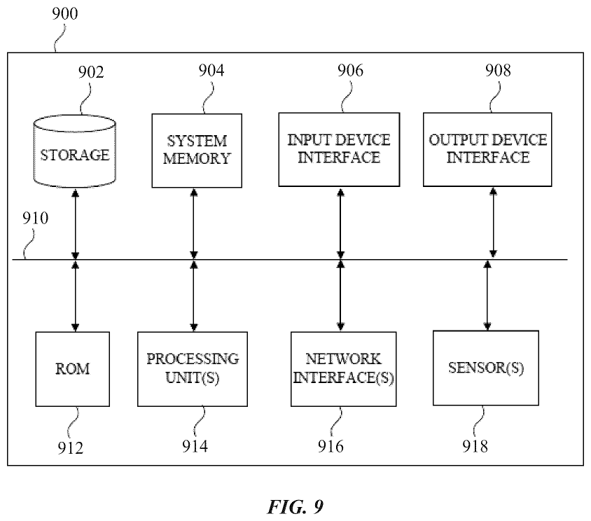

FIG. 9 illustrates an example electronic system with which aspects of the present disclosure may be implemented, in accordance with one or more implementations. The electronic system 900 can be, and/or can be a part of, any server for generating the features and processes described in reference to FIGS. 1-8, including but not limited to a parent frame. The electronic system 900 may include various types of computer-readable media and interfaces for various other types of computer-readable media. The electronic system 900 includes one or more processing unit(s) 914, a persistent storage device 902, a system memory 904 (and/or buffer), an input device interface 906, an output device interface 908, a bus 910, a ROM 912, one or more processing unit(s) 914, one or more network interface(s) 916, one or more sensor(s) 918, and/or subsets and variations thereof.

The bus 910 collectively represents all system, peripheral, and chipset buses that communicatively connect the numerous internal devices of the electronic system 900. In one or more implementations, the bus 910 communicatively connects the one or more processing unit(s) 914 with the ROM 912, the system memory 904, and the persistent storage device 902. From these various memory units, the one or more processing unit(s) 914 retrieves instructions to execute and data to process in order to execute the processes of the subject disclosure. The one or more processing unit(s) 914 can be a single processor or a multi-core processor in different implementations.

The ROM 912 stores static data and instructions that are needed by the one or more processing unit(s) 914 and other modules of the electronic system 900. The persistent storage device 902, on the other hand, may be a read-and-write memory device. The persistent storage device 902 may be a non-volatile memory unit that stores instructions and data even when the electronic system 900 is off. In one or more implementations, a mass-storage device (such as a magnetic or optical disk and its corresponding disk drive) may be used as the persistent storage device 902.

In one or more implementations, a removable storage device (such as a floppy disk, flash drive, and its corresponding disk drive) may be used as the persistent storage device 902. Like the persistent storage device 902, the system memory 904 may be a read-and-write memory device. However, unlike the persistent storage device 902, the system memory 904 may be a volatile read-and-write memory, such as RAM. The system memory 904 may store any of the instructions and data that one or more processing unit(s) 914 may need at runtime. In one or more implementations, the processes of the subject disclosure are stored in the system memory 904, the persistent storage device 902, and/or the ROM 912. From these various memory units, the one or more processing unit(s) 914 retrieves instructions to execute and data to process in order to execute the processes of one or more implementations.

The bus 910 also connects to the input device interfaces 906 and output device interface 908. The input device interface 906 enables a user to communicate information and select commands to the electronic system 900. Input devices that may be used with the input device interface 906 may include, for example, alphanumeric keyboards, touch screens, and pointing devices. The output device interface 908 may enable the electronic system 900 to communicate information to users. For example, the output device interface 908 may provide the display of images generated by electronic system 900. Output devices that may be used with the output device interface 908 may include, for example, printers and display devices, such as a liquid crystal display (LCD), a light emitting diode (LED) display, an organic light emitting diode (OLED) display, a flexible display, a flat panel display, a solid-state display, a projector, or any other device for outputting information.

One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

The bus 910 also couples the electronic system 900 to one or more networks and/or to one or more network nodes through the one or more network interface(s) 916. In this manner, the electronic system 900 can be a part of a network of computers (such as a local area network, a wide area network, an Intranet, or a network of networks, such as the Internet). Any or all components of the electronic system 900 can be used in conjunction with the subject disclosure.

The bus 910 also connects to sensor(s) 918. The sensor(s) 918 may include one or more components for capturing data, such as audio and/or image data. The captured data may be used for enrolling in a credential, validating a credential, accessing a service, and/or any other process for establishing the identity of the user.

Implementations within the scope of the present disclosure can be partially or entirely realized using a tangible computer-readable storage medium (or multiple tangible computer-readable storage media of one or more types) encoding one or more computer-readable instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessors or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way), all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used in this specification and any claims of this application, the terms “base station,” “receiver,” “computer,” “server,” “processor,” and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refers to only A, only B, or only C; any combination of A, B, and C; and/or at least one of each of A, B, and C.

The predicate words “configured to,” “operable to,” and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, one or more implementations, one or more implementations, an embodiment, the embodiment, another embodiment, one or more implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any implementation described herein as “exemplary” or as an “example” is not necessarily to be construed as preferred or advantageous over other implementations. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method, comprising:
displaying a parent frame that includes first content and a first inline frame that includes second content, the first content of the parent frame being provided by a platform server and second content of the first inline frame being provided by a service provider server separate from the platform server;
establishing, between the parent frame and the first inline frame, a message channel;
receiving, within the first inline frame, a request via the message channel to open a second inline frame;
communicating, by the first inline frame and to the parent frame, the request via the message channel to open the second inline frame;
opening, by the parent frame, the second inline frame; and
displaying, in the second inline frame, third content provided by the service provider server.

2. The method of claim 1, wherein communicating, by the first inline frame and to the parent frame, the request to open the second inline frame comprises a size and location for opening the second inline frame.

3. The method of claim 1, further comprising:
receiving, by the first inline frame and from the parent frame, an identifier corresponding to the second inline frame, wherein the third content is displayed in the second inline frame based at least in part on the received identifier.

4. The method of claim 1, further comprising:
monitoring for a change in one or more dimensions of the parent frame; and
in response to the change in the one or more dimensions of the parent frame, adjusting one or more dimensions of the second inline frame.

5. The method of claim 1, further comprising:
monitoring a change in one or more dimensions of the first inline frame; and
in response to determining, based on the monitoring, the change of the one or more dimensions of the first inline frame, adjusting one or more dimensions of the second inline frame.

6. The method of claim 1, further comprising providing, via the second inline frame, a request based on the third content.

7. The method of claim 6, further comprising in response to completion of the request, providing a second request to close the second inline frame.

8. The method of claim 1, wherein receiving the request to open the second inline frame comprises identifying a user interaction with the first inline frame.

9. The method of claim 1, further comprising isolating, based on the message channel, the second inline frame from the parent frame.

10. A system comprising:
a memory; and
a processor configured to:
receive, from a parent frame via first instructions, a first message to initiate an action;
provide, via second instructions provided by a service provider server, a second message to generate an inline frame; and
in response to the parent frame generating the inline frame:
generate, via the second instructions, a user interface comprising a request for an account credential to perform the action; and
render, within the inline frame, the user interface.

11. The system of claim 10, wherein the processor is further configured to in response to receiving the account credential, process the account credential.

12. The system of claim 11, wherein the processor is further configured to in response to receiving an approval of the account credential, provide, via the second instructions, a third message to the parent frame corresponding to the approval.

13. The system of claim 12, wherein the processor is further configured to provide, via the second instructions, a fourth message to the parent frame to close the inline frame.

14. The system of claim 11, wherein the account credentials are isolated from the parent frame.

15. The system of claim 10, wherein the processor is further configured to:
monitor the parent frame; and
in response to a determination, based on the monitoring, of a resize of the parent frame, resize the inline frame.

16. The system of claim 10, wherein the processor is further configured to provide, via the second instructions, a location of the inline frame relative to the parent frame.

17. A non-transitory computer-readable medium, comprising:
computer-readable instructions that, when executed by a processor, cause the processor to perform one or more operations comprising:
receiving, from a parent frame provided based on first instructions, a first request for an action to be taken on one or more items presented on the parent frame;
in response to the first request, providing, via second instructions, a second request to generate an inline frame over the parent frame;
generating, by the second instructions and within the inline frame, a user interface for providing an account credential; and
in response to the account credential being received in the user interface:
processing the account credential; and
providing, via the second instructions to the parent frame, a notification that the action is complete.

18. The non-transitory computer-readable medium of claim 17, further comprising providing, via the second instructions, a third request to close the inline frame.

19. The non-transitory computer-readable medium of claim 17, further comprising providing location data to position the inline frame over a portion of the parent frame.

20. The non-transitory computer-readable medium of claim 17, further comprising:
receiving, via third instructions, a third request to open a second inline frame over the parent frame; and
providing, by the second instructions and within the inline frame, a second user interface for display in the second inline frame.
